(19) United States
(12) Patent Application Publication
(10) Pub. No.: US 2022/0194631 A1
(43) Pub. Date: Jun. 23, 2022

(54) OPERATION SUPPORTING SYSTEM OF AIRCRAFT

(71) Applicant: SUBARU CORPORATION, Tokyo (JP)

(72) Inventors: Yasuji YAMAGISHI, Tokyo (JP); Kaoru SHIZUNO, Tokyo (JP); Shinichiro NAKAHIRA, Tokyo (JP); Kouki ANDOU, Tokyo (JP); Daisuke KATO, Tokyo (JP); Naomi FUCHIKAMI, Tokyo (JP); Naoto MOURI, Tokyo (JP)

(21) Appl. No.: 17/691,589

(22) Filed: Mar. 10, 2022

Related U.S. Application Data
(63) Continuation of application No. PCT/JP2020/037784, filed on Oct. 6, 2020.

(30) Foreign Application Priority Data
Oct. 24, 2019 (JP) 2019-193879

(51) Int. Cl. B64F 5/60; G06Q 10/00; B64D 31/00

(52) U.S. Cl. CPC B64F 5/60; B64D 31/00; G06Q 10/20

(57) ABSTRACT

According to one implementation, an operation supporting system of an aircraft includes circuitry configured to: automatically acquire, from an aircraft, identification data and flight time of the aircraft; automatically specify exchange time of at least one part of the aircraft, based on the flight time of the aircraft; and automatically determine order time of the at least one part, based on the exchange time of the at least one part.

### CROSS REFERENCES TO RELATED APPLICATIONS

This is a continuation of Application PCT/JP2020/037784, filed on Oct. 6, 2020.

This application is based upon and claims the benefit of priority from Japanese Patent Application No. 2019-193879, filed on Oct. 24, 2019; the entire contents of which are incorporated herein by reference.

### FIELD

Implementations described herein relate generally to an operation supporting system of an aircraft, a method of supporting operation of an aircraft and a recording medium with a program of supporting operation of an aircraft recorded.

### BACKGROUND

Conventionally, various systems for supporting operation of aircrafts have been proposed. For example, a system for supporting maintenance of an aircraft on the ground, a system for automatically pursuing navigation information and the like during flight of an aircraft, a system for communication between an aircraft and the ground, and the like, have been proposed (for example, refer to Japanese Patent Application Publication JP2018-520946A, Japanese Patent Application Publication JP2012-071829A and Japanese Patent Application Publication JP2010-524750A).

An object of the present invention is to shorten a down time of an aircraft caused by exchanging aircraft parts.

### SUMMARY OF THE INVENTION

In general, according to one implementation, an operation supporting system of an aircraft includes circuitry configured to: automatically acquire, from an aircraft, identification data and flight time of the aircraft; automatically specify exchange time of at least one part of the aircraft, based on the flight time of the aircraft; and automatically determine order time of the at least one part, based on the exchange time of the at least one part.

Further, according to one implementation, a method of supporting operation of an aircraft includes automatically determining the order time of the at least one part of the aircraft using the above-mentioned operation supporting system.

Further, according to one implementation, a method of supporting operation of an aircraft includes: acquiring, from an aircraft, identification data and flight time of the aircraft automatically by a computer; specifying exchange time of at least one part of the aircraft, based on the flight time of the aircraft automatically by the computer; and determining order time of the at least one part, based on the exchange time of the at least one part automatically by the computer.

Further, according to one implementation, a recording medium with a program of supporting operation of an aircraft recorded is provided. The program makes a computer execute to: automatically acquire, from an aircraft, identification data and flight time of the aircraft; automatically specify exchange time of at least one part of the aircraft, based on the flight time of the aircraft; and automatically determine order time of the at least one part, based on the exchange time of the at least one part.

### BRIEF DESCRIPTION OF THE DRAWINGS

In the accompanying drawings:

FIG. 1 is a configuration diagram of an operation supporting system of an aircraft according to an implementation of the present invention;

FIGS. 2A and 2B show graphs indicating concrete examples of operation information on the aircrafts respectively;

FIG. 3 shows a graph indicating an example of a method for predicting an exchange time and an order time of a part of the aircraft 2;

FIGS. 4A and 4B show graphs indicating differences in periods of use and lead times required for manufacturing of respective parts included in the aircraft;

FIG. 5 is a sequence chart showing an example of a flow for automatically determining an order time of a part of the aircraft to exchange the part using the operation supporting system of the aircraft shown in FIG. 1,

FIG. 6 shows the conventional flow for exchanging a part of an aircraft; and

FIG. 7 shows a flow for exchanging a part of the aircraft including determination of an order time of the part by the operation supporting system shown in FIG. 1.

### DETAILED DESCRIPTION

An operation supporting system of an aircraft, a method of supporting operation of an aircraft and a recording medium with a program of supporting operation of an aircraft recorded according to implementations of the present invention will be described with reference to accompanying drawings.

### An Operation Supporting System of an Aircraft

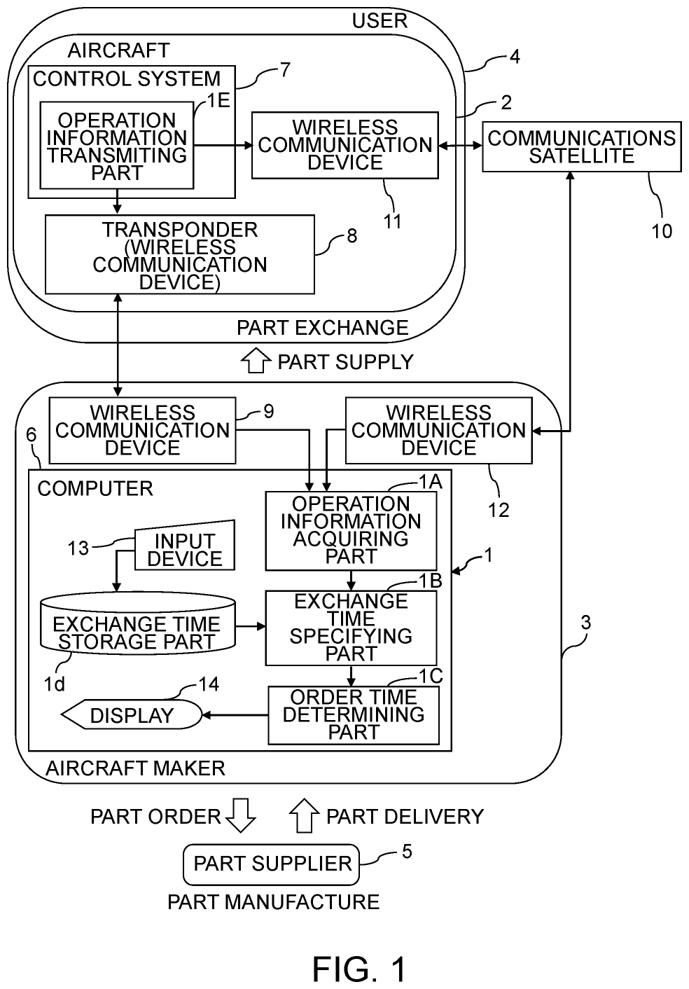

FIG. 1 is a configuration diagram of an operation supporting system of an aircraft according to an implementation of the present invention.

An operation supporting system 1 attains reduction in down time of an aircraft 2 by allowing an aircraft maker 3, which supports the aircraft 2, to supply a user of the aircraft 2 with various parts, such as expendable parts, which have to be replaced, at appropriate times. Each part to be replaced can be ordered by the aircraft maker 3 to a part supplier 5, and then manufactured by the part supplier 5, for example. As a matter of course, each part may be ordered to a manufacturing department of the aircraft maker 3, and then manufactured in the manufacturing department of the aircraft maker 3.

The aircraft 2 may be any of a fixed wing aircraft, a rotorcraft, a manned aircraft, a UAV (Unmanned Aerial Vehicle) and an OPV (Optionally Piloted Vehicle) which is a hybrid aircraft of a manned aircraft and an unmanned aerial vehicle. A UAV is also called a drone, and an unmanned rotorcraft, such as a multi-copter or helicopter, is typical. An OPV is an unmanned aerial vehicle which a pilot can also board on and control.

When the aircraft 2 is a rotorcraft, typical examples of a part to be exchanged and ordered include parts having fatigue lives, such as a rotor blade, a transmission and a drive shaft. Meanwhile, when the aircraft 2 is a fixed wing aircraft, typical examples of a part to be exchanged and ordered include parts having fatigue lives, such as a propeller, a pressure bulkhead and component parts of an engine. Generally, the aircraft 2 has not less than 100 kinds of parts to be replaced, and therefore requires such complicated work that workers manage exchange times of many parts while recording durations of use thereof.

Furthermore, although consumption due to fatigue of parts progresses depending on duration of use of the parts respectively, some parts consume during only flight of the aircraft 2 while other parts consume as long as the engine of the aircraft 2 is driving even when the aircraft 2 is not flying. As for each part which consumes during only flight of the aircraft 2, the accumulated total flight time of the aircraft 2 is a period of use of the part. Meanwhile, each part which consumes during driving of the engine of the aircraft 2 also consumes as long as the engine is driving even when the aircraft 2 are running or standing on the ground. Therefore, a period of use of each part which consumes during driving of the engine of the aircraft 2 is the accumulated total driving time of the engine, and is longer than that of each part which consumes during only flight of the aircraft 2. Accordingly, it is necessary to estimate periods of use of parts based on criteria different from each other for each part.

Thus, the operation supporting system 1 has a function to automatically determine exchange times and order times of many parts of the aircraft 2. The operation supporting system 1 can be built by electronic circuitry, such as a computer 6, placed in the aircraft maker 3, and electronic circuitry, such as a computer, included in a control system 7 mounted on the aircraft 2, into which operation support programs have been read respectively.

As a concrete example, the operation supporting system 1 can be composed of the computer 6 placed in the aircraft maker 3, which functions as an operation information acquiring part 1A, an exchange time specifying part 1B, an order time determining part 1C and an exchange time storage part 1D, and the control system 7 mounted on the aircraft 2, which functions as an operation information transmitting part 1E.

In this case, the operation support program installed into the computer 6 placed in the aircraft maker 3 makes the computer 6 function as the operation information acquiring part 1A, the exchange time specifying part 1B, the order time determining part 1C and the exchange time storage part 1D while the operation support program installed into the control system 7 mounted on the aircraft 2 makes the computer function as the operation information transmitting part 1E. The operation information acquiring part 1A, the exchange time specifying part 1B, the order time determining part 1C and the exchange time storage part 1D are formed in the computer 6 on the ground while the operation information transmitting part 1E is formed in the aircraft 2.

The operation information acquiring part 1A has a function to automatically acquire, from the aircraft 2 or each of the aircrafts 2, operation information, including at least identification data and flight time, on each aircraft 2. The exchange time specifying part 1B has a function to automatically specify respective exchange times of parts of each aircraft 2, based on the operation information, such as the flight time, on each aircraft 2 acquired in the operation information acquiring part 1A. The order time determining part 1C has a function to automatically determine respective order times of the parts, based on the exchange times of the parts specified in the exchange time specifying part 1B. The exchange time storage part 1D has a function to store reference information for specifying exchange times of the parts of each aircraft 2, based on operation information, such as flight time, on each aircraft 2. The operation information transmitting part 1E has a function to transmit, toward the operation information acquiring part 1A, operation information including identification data and flight time of the aircraft 2 on which the operation information transmitting part 1E has been mounted.

Therefore, the operation support program installed into the computer 6 placed in the aircraft maker 3 makes the computer 6 execute to: automatically acquire operation information on the aircraft 2 or each of the aircrafts 2 from each aircraft 2; automatically specify respective exchange times of parts of each aircraft 2 based on the operation information on each aircraft 2; and automatically determine order times of the parts based on the specified exchange times of the parts respectively. Meanwhile, the operation support program installed into the control system 7 mounted on the aircraft 2 makes the control system 7 of on the aircraft 2 execute to transmit operation information, including identification data and flight time, on the aircraft 2 toward the operation information acquiring part 1A.

The communications between the operation information acquiring part 1A placed on the ground and the operation information transmitting part 1E mounted on the aircraft 2 can be established using an existing device or existing devices provided in the aircraft 2. The aircraft 2 usually has a transponder 8 including a wireless communication device. Accordingly, a wireless communication device 9 can be also placed on the aircraft maker 3 side in order to communicate with the transponder 8 of the aircraft 2. That is, the wireless communication device 9 for communicating with the transponder 8 of the aircraft 2 may be coupled to the computer 6 on the aircraft maker 3 side. As a matter of course, an existing wireless communication device placed in a control center of the aircraft 2 may be used. Each wireless communication device can consist of a radio.

In addition, satellite communications utilizing a communications satellite 10 may be established between the operation information acquiring part 1A placed on the ground and the operation information transmitting part 1E mounted on the aircraft 2. In that case, wireless communication devices 11 and 12 for the satellite communications are disposed in the aircraft 2 and on the ground respectively. Specifically, the wireless communication device 11 for the satellite communications may be coupled to the control system 7 of the aircraft 2 while the wireless communication device for the satellite communications may be also coupled the computer 6 on the aircraft maker 3 side.

The communication distance of the transponder 8 is approximately a few hundred kilometers. Therefore, when the operation information acquiring part 1A is made to communicate with only the aircraft 2 within the communication distance of the transponder 8, communications can be established without adding communication equipment to the aircraft 2. Conversely, using satellite communications makes it possible to establish communications between the aircraft 2 and the operation information acquiring part 1A on the ground without restriction due to the communication distance of the transponder 8. As a matter of course, the wireless communications may be also established only by satellite communications without utilizing the transponder 8. Moreover, communications meeting another communication standard may be established.

The control system 7 of the aircraft 2 has the function as the operation information transmitting part 1E which transmits operation information, including identification data and flight time, on the aircraft 2 toward the ground through the transponder 8 or the satellite communications. Accordingly, the operation information can be automatically transmitted from the aircraft 2 in response to a request from the operation information acquiring part 1A on the ground.

More specifically, when the operation information acquiring part 1A on the aircraft maker 3 side transmits an interrogation signal, which requests a transmission of the operation information on the aircraft 2, towards the aircraft 2 wirelessly through the wireless communication device 9 or the wireless communication device 12 placed on the ground, the operation information transmitting part 1E mounted on the aircraft 2 receives the interrogation signal through the transponder 8 or the wireless communication device 11 provided in the aircraft 2. When the operation information transmitting part 1E has received the interrogation signal, the operation information transmitting part 1E transmits the operation information on the aircraft 2 as an answer signal through the transponder 8 or the wireless communication device 11. Accordingly, the operation information acquiring part 1A on the aircraft maker 3 side receives the answer signal transmitted, as the response to the interrogation signal, from the transponder 8 or the wireless communication device 11 of the aircraft 2 through the wireless communication device or the wireless communication device 12, and thereby acquires the operation information on the aircraft 2.

The operation information obtained in the operation information acquiring part 1A is used for grasping periods of use of parts in order to predict exchange times of the parts respectively. As mentioned above, a period of use of a part may be considered as the accumulated total of flight time of the aircraft 2 or may be considered as the accumulated total of driving time of the engine. Accordingly, the operation information on the aircraft 2 transmitted from the operation information transmitting part 1E of the aircraft 2 to the operation information acquiring part 1A on the aircraft maker 3 side may include the driving time of the engine included in the aircraft 2 in addition to the identification data and the flight time of the aircraft 2.

That is, the operation information acquiring part 1A can acquire operation information for every aircraft 2, including at least identification data and flight time of the aircraft 2, and further including driving time of the engine in case of predicting an exchange time of at least one part according to the driving time of the engine. The operation information on the aircraft 2 or the aircrafts 2 acquired by the operation information acquiring part 1A is notified to the exchange time specifying part 1B.

As mentioned above, the exchange time specifying part 1B specifies prospective exchange times of parts based on the operation information on the aircraft 2 or the aircrafts 2. The exchange times of the parts can be each specified in advance based on flight time or driving time of the engine of each aircraft 2.

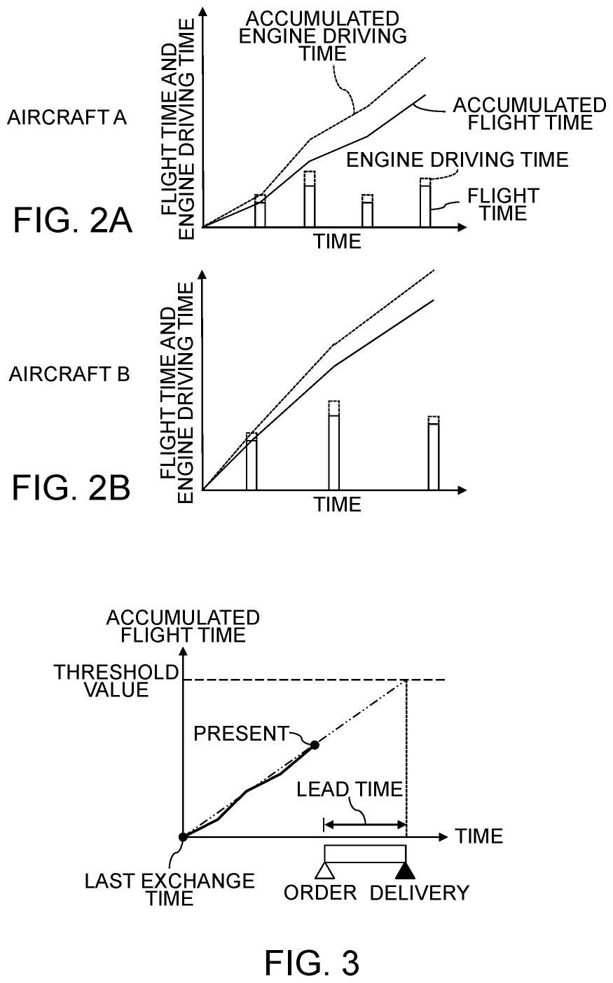

FIGS. 2A and 2B show graphs indicating concrete examples of operation information on the aircrafts 2 respectively.

The upper graph in FIG. 2A shows operation information on an aircraft A. Meanwhile, the lower graph in FIG. 2B shows operation information on another aircraft B. In each graph, the horizontal axis represents the time while the vertical axis represents flight time and driving time of the engine of the aircraft A or B. In each graph, each solid line represents flight time of the aircraft A or B, each dotted line represents driving time of the engine included in the aircraft A or B, each bar graph represents flight time or driving time of the engine per flight of the aircraft A or B, and each polygonal line represents the accumulation of flight time or driving time of the engine of the aircraft A or B.

As exemplified in FIGS. 2A and 2B, the accumulation of flight time and the accumulation of engine driving time of the aircraft A differ from those of the aircraft B even when the elapsed time is the same. For example, although FIG. 2A shows four flights of the aircraft A during a record period while FIG. 2B shows three flights of the aircraft B during the record period, the accumulation of flight time of the aircraft B is longer than that of the aircraft A since the average flight time per one flight of the aircraft B is longer than that of the aircraft A.

Meanwhile, the engine driving time is longer than the flight time since the engine is driving while the aircraft A or B is running in an airport or the like. When the engine is also driving while the aircraft A or B is standing, the standing time is added to the engine driving time.

Accordingly, the exchange time specifying part 1B can specify an exchange time of each part of every aircraft 2, based on accumulations of flight time of the aircrafts 2 and/or accumulations of driving time of the engines. Specifically, an exchange time of each part whose exchange time is defined according to flight time of the aircraft 2 can be specified based on accumulation of the flight time of the aircraft 2 while an exchange time of each part whose exchange time is defined according to driving time of the engine can be specified based on accumulation of the engine driving time.

FIG. 3 shows a graph indicating an example of a method for predicting an exchange time and an order time of a part of the aircraft 2.

In FIG. 3, the horizontal axis represents the elapsed time from the previous exchange time of a part while the vertical axis represents the accumulated flight time of the aircraft 2. As shown in FIG. 3, the forward exchange time of the part can be estimated based on the accumulated flight time of the aircraft 2 within the elapsed time from the previous exchange time of the part to the present.

More specifically, the forward flight time of the aircraft 2 can be predicted by liner approximation or curve approximation of time change of the past accumulated flight time of the aircraft 2. FIG. 3 shows an example of linearly approximating the time change of the accumulated flight time of the aircraft 2. The forward accumulated flight time becomes computable by fitting the time change of the past accumulated flight time by the least squares method or the like to obtain a straight line or a curved line.

Accordingly, the accumulated flight time of the aircraft 2 corresponding to an upper limit of a period of use of a part can be set as a threshold value as exemplified in FIG. 3. Thereby, the forward exchange time of the part can be calculated by threshold processing of an approximated straight line or an approximated curved line representing the accumulated flight time of the aircraft 2. That is, respective exchange times of parts can be specified based on the predicted forward flight time of the aircraft 2.

Although FIG. 3 shows an example of a case where an exchange time of a part of the aircraft 2 is specified based on the accumulated flight time of the aircraft 2, it is similar in a case where an exchange time of a part related to the engine out of parts of the aircraft 2 is specified based on the accumulated driving time of the engine.

When the exchange time specifying part 1B has specified an exchange time of a part, the specified exchange time of the part is notified to the order time determining part 1C. Then, the order time determining part 1C can determine an order time of the part so that the part may be delivered by the exchange time of the part, as shown by a Gantt chart below the graph in FIG. 3. Specifically, a time retrospective from the exchange time of the part by a lead time required from an order of the part to a delivery can be determined as the order time of the part. In other words, a day after a period derived by subtracting the lead time, including a manufacture time of the part and the like, from a remaining period of use of the part can be determined as the order time of the part.

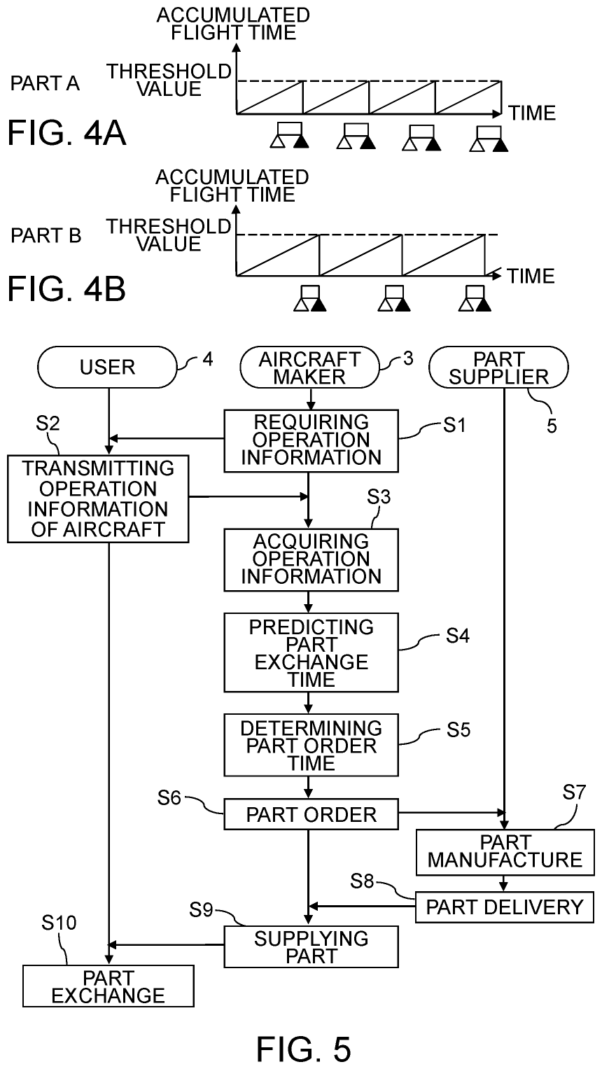

FIGS. 4A and 4B show graphs indicating differences in periods of use and lead times required for manufacturing of respective parts included in the aircraft 2.

In each graph of FIGS. 4A and 4B, the horizontal axis represents the time while the vertical axis represents the accumulated flight time of the aircraft 2. Even when different parts A and B are included in the same aircraft 2, periods of use and lead times required for manufacturing may differ from each other. In this case, even when the part A and the part B started to be used simultaneously, order times and exchange times of the part A are different from those of the part B, as shown in FIGS. 4A and 4B.

Even when the change rate of the accumulated flight time of the aircraft 2 is the same between the part A and the part B, the upper limit of the period of use of the part A occasionally differs from that of the part B. In this case, the period of part exchange of the part A also differs from that of the part B since the threshold value for the part A to the accumulated flight time of the aircraft 2 differ from that for the part B as shown in FIG. 4. Therefore, the previous exchange time of the part A, which is the starting point of the accumulated flight time of the aircraft 2 for predicting the next exchange time of the part A, is different from that of the part B. Accordingly, the exchange time specifying part 1B and the order time determining part 1C are configured to specify and determine exchange times and order times respectively for each part A or B. This is the same in a case where exchange times and order times of the part A and the part B are specified and determined based on the accumulated engine driving time.

For that purpose, it is necessary to previously determine reference information relating a period of use and an exchange time of each part to the accumulated flight time or engine driving time of the aircraft 2 after the old part has been replaced with the new part, more specifically, the threshold value for each part to the accumulated flight time or engine driving time of the aircraft 2 after the old part has been replaced with the new part.

Thus, the exchange time storage part 1D stores respective exchange times and periods of use of parts to be exchanged of the aircraft 2, each related to the accumulated flight time or engine driving time of the aircraft 2 after the old part has been replaced with the new part. Specifically, the threshold value for each part to the accumulated flight time or engine driving time of the aircraft 2 after the old part has been replaced with the new part is stored in the exchange time storage part 1D as the reference information indicating the exchange time and the period of use of each part. A threshold value indicating the exchange time and the period of use of a part can be added or updated at any time by operation of an input device 13.

Thereby, the exchange time specifying part 1B can refer to the exchange time storage part 1D to specify the exchange time of each part whose exchange time has been related to the accumulated flight time of the aircraft 2, based on the flight time of the aircraft 2 acquired by the operation information acquiring part 1A. and to specify the exchange time of each part whose exchange time has been related to the accumulated driving time of the engine, based on the engine driving time acquired by the operation information acquiring part 1A.

Some parts to be exchanged of the aircraft 2 have short lead times. Accordingly, parts whose exchange times and order times are specified and determined by the exchange time specifying part 1B and the order time determining part 1C respectively may be restricted to main parts having long lead times. For example, the exchange time specifying part 1B and the order time determining part 1C may specify and determine exchange times and order times of targeted parts, to which fatigue lives have been defined, including at least one of a blade of a rotorcraft, a transmission of a rotorcraft, a drive shaft of a rotorcraft, a propeller of a fixed wing aircraft and parts related to an engine of a fixed wing aircraft.

The respective order times of parts determined in the order time determining part 1C can be displayed on a display 14 of the computer 6 provided in the aircraft maker 3. Thereby, a person in charge of the aircraft maker 3 who supports the aircraft 2 can order each part of the aircraft 2 to the part supplier 5 or the like at an appropriate time. As a matter of course, the operation supporting system 1 may be coupled to an order receipt management system of parts, provided on the part supplier 5 side, through a network so as to automate each order of a part.

### A Method of Supporting Operation of an Aircraft

Next, a method of supporting operation of the aircraft 2 using the operation supporting system 1 of the aircraft 2 will be described.

FIG. 5 is a sequence chart showing an example of a flow for automatically determining an order time of a part of the aircraft 2 to exchange the part using the operation supporting system 1 of the aircraft 2 shown in

FIG. 1.

Firstly, in step S1, the operation supporting system provided in the aircraft maker 3 requires a transmission of operation information to the aircraft 2 of the user 4. Specifically, the operation information acquiring part 1A of the operation supporting system 1 generates an interrogation signal for asking for the operation information on the aircraft 2, and transmits the generated interrogation signal as a wireless signal from the wireless communication device 9 or the wireless communication device 12 provided in the aircraft maker 3.

Then, the interrogation signal is received by the transponder 8 provided in the aircraft 2. Alternatively, the interrogation signal is received by the wireless communication device 11 provided in the aircraft 2 through the satellite communication utilizing the communications satellite 10.

Next, in step S2, the operation information is transmitted from the aircraft 2. Specifically, the operation information transmitting part 1E of the control system 7 which controls the aircraft 2 acquires the interrogation signal transmitted from the aircraft maker 3, and refers to flight time and engine driving time of the aircraft 2 recorded in storage of the control system 7. Then, the operation information transmitting part 1E generates an answer signal representing the operation information on the aircraft 2 by relating the referred flight time and engine driving time of the aircraft 2 with the identification data of the aircraft 2, and transmits the generated answer signal as a wireless signal from the transponder 8 or the wireless communication device 11 for the satellite communications provided in the aircraft 2.

Next, in step S3, the operation information on the aircraft 2 is acquired by the operation supporting system provided in the aircraft maker 3. Specifically, the operation information acquiring part 1A of the operation supporting system 1 acquires the answer signal, transmitted from the aircraft 2, through the wireless communication device 9 or the wireless communication device 12 provided in the aircraft maker 3. Thereby, the operation information acquiring part 1A can acquire the operation information including the flight time and engine driving time of the aircraft 2, related with the identification data of the aircraft 2, as exemplified in FIG. 2A or 2B. That is, the operation information on the aircraft 2 can be automatically acquired from the aircraft 2 by the computer 6 provided in the aircraft maker 3.

Next, in step S4, an exchange time of each part included in the aircraft 2 is predicted by the operation supporting system 1 provided in the aircraft maker 3. That is, exchange times of parts of the aircraft 2 can be automatically specified by the computer 6 based on the operation information on the aircraft 2. More specifically, the exchange time specifying part 1B of the operation supporting system 1 acquires the operation information on the aircraft 2 from the operation information acquiring part 1A, and predicts an exchange time of each part based on the acquired operation information.

For example, an approximated straight line or curved line expressing the increase in the accumulated flight time or engine driving time of the aircraft 2 after the last exchange time of each part can be obtained by fitting the increase in flight time per unit time or engine driving time per unit time of the aircraft 2 after the last exchange time of each part, by the least squares method or the like, as exemplified in FIG. 3. Thereby, the forward accumulated flight time or engine driving time of the aircraft 2 after the last exchange time of each part can be calculated by extrapolation processing in the time direction of the obtained approximated straight line or curved line.

Next, the exchange time specifying part 1B refers to the threshold values, representing the lives of respective parts, stored in the exchange time storage part 1D, and performs threshold processing of the forward accumulated flight time or engine driving time of the aircraft 2 after the last exchange time of each part. Since the threshold values for the threshold processing and the last exchange times of the parts differ from each other among the parts, the threshold processing is performed for each part, as exemplified in FIGS. 4A and 4B. Thereby, the times when the forward accumulated flight times or engine driving times of the aircraft 2 reach the threshold values respectively can be predicted as the respective optimum exchange times of the parts.

Next, in step S5, the order times of the parts included in the aircraft 2 are determined by the operation supporting system 1 provided in the aircraft maker 3. That is, the order times of the parts can be automatically determined by the computer 6 based on the exchange times of the parts respectively. More specifically, the order time determining part 1C of the operation supporting system 1 acquires the exchange times of the parts from the exchange time specifying part 1B. Then, the order time determining part 1C determines the delivery dates or the like of the parts so that the delivery deadlines may be before the exchange times of the parts respectively, and also determines the order times of the parts to the times which go back from the delivery deadlines of the parts by the lead times required for production of the parts respectively. The order times of the parts determined in the order time determining part 1C can be displayed on the display 14.

Next, in step S6, a person in charge of the aircraft maker 3 which supports the aircraft 2 sequentially places orders of the parts at the order times determined in the order time determining part 1C respectively. Accordingly, in step S7, the part supplier 5, which has sequentially received the orders of the parts, sequentially starts to produce the parts respectively.

When the parts have been sequentially completed, the parts are sequentially delivered from the part supplier to the aircraft maker 3 respectively, in step S8. Then, the aircraft maker 3 sequentially supplies the user 4 of the aircraft 2 with the parts respectively, in step S9.

Thereby, in step S10, a person in charge on the user 4 side or a person in charge of the aircraft maker 3 who has come to the user 4 side can exchange each part of the aircraft 2. Since the respective parts of the aircraft 2 have started to be produced in advance according to their lives respectively, each part can be exchanged at an appropriate exchange time without waiting for the production of the part.

Note that, the operation support of the aircraft 2, including determination of order times of parts, shown in FIG. 5 can be also performed by targeting parts of a plurality of the aircrafts 2 simultaneously and individually.

### Effects

As described above, the operation supporting system 1, and the method and program of supporting operation of the aircraft 2 or the aircrafts 2 automatically record operation information on the aircraft 2 or the aircrafts 2, and optimize order times of parts based on the recorded operation information on the aircraft 2 or the aircrafts 2.

Accordingly, the operation supporting system 1, and the method and program of supporting operation of the aircraft 2 or the aircrafts 2 allow shortening of down time of the aircraft 2 or the aircrafts 2 resulting from each part exchange of the aircraft 2 or the aircrafts 2.

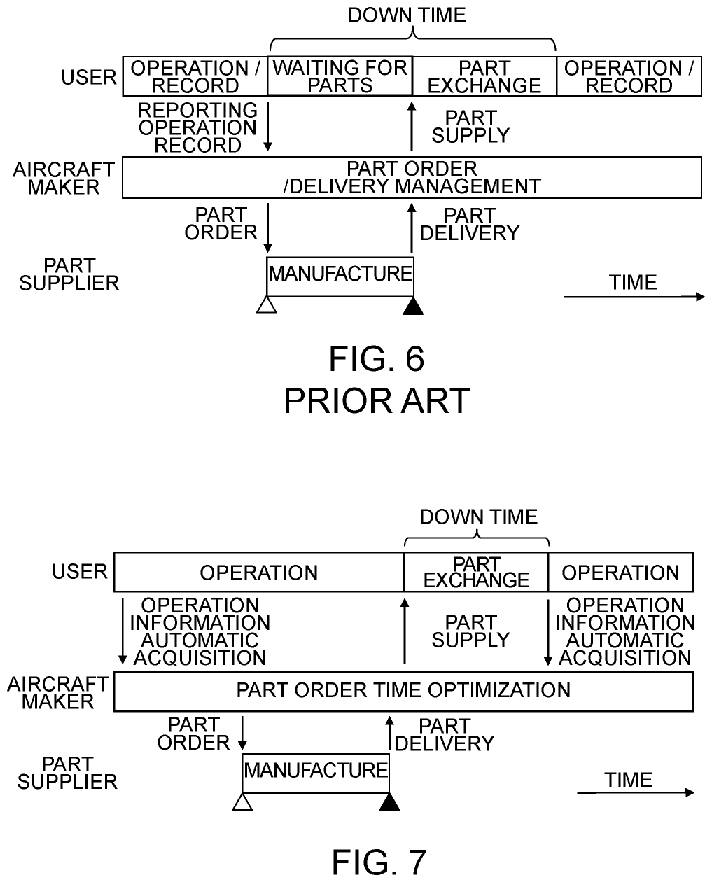

FIG. 6 shows the conventional flow for exchanging a part of an aircraft. FIG. 7 shows a flow for exchanging a part of the aircraft 2 including determination of an order time of the part by the operation supporting system 1 shown in FIG. 1.

As shown in FIG. 6, a pilot belonging to the user 4 of an aircraft has conventionally recorded an operation time of the aircraft as an operation record on a recording paper for every flight, and then calculated an accumulated flight time in many cases. In particular, a pilot of a small aircraft records and calculates them by hand in many cases. Each operation record including the accumulated flight time of an aircraft recorded on the user 4 side is provided with the aircraft maker 3 which supports the aircraft.

The aircraft maker 3 places an order for a part to the part supplier 5, based on the operation record of the aircraft and lives of parts. Then, the part is produced by the part supplier 5. When the part has been completed, the part delivered from the part supplier 5 to the aircraft maker 3 is supplied from the aircraft maker 3 to the user 4 side. Then, operation of the aircraft is resumed after the part of the aircraft has been exchanged.

However, when a part is ordered based on operation information recorded by a pilot or the like in the conventional way, not only a work for recording by hand is cumbersome, but there is a problem that human errors, such as omission in entry and a mistake in writing of operation time of an aircraft, a mistake in calculation of an accumulated flight time, a mistake in reading of an operation record, and a loss of an operation recording paper, may arise easily. When a human error arises in a record of operation information, a part is not ordered at an appropriate time so that the part may be delivered by an exchange time of the part, which causes a state of waiting for the part. In this case, the down time of the aircraft is the sum of a period of waiting for the part and a period required for exchanging the part.

In contrast, the operation supporting system 1 can allow the aircraft maker 3 to automatically obtain operation information from the aircraft 2 of the user 4 as shown in FIG. 7. Accordingly, not only the work for recording operation times on a recording paper by a pilot belonging to the user 4 of the aircraft 2 and the work for calculating the accumulated time can be made unnecessary, but operation records of the aircraft 2 can be correctly controlled in the aircraft maker 3 by preventing human errors.

As a result, a part can be ordered from the aircraft maker 3 to the part supplier 5 at an appropriate time according to an exchange time of the part. In particular, an order time of a part can be optimized in the aircraft maker 3 by information processing for predicting an exchange time of the part. In addition, the work that a person in charge of the aircraft maker 3 refers to operation records of the aircraft 2, and specifies a part to be exchanged out of not less than 100 parts and an order time of the part can be made unnecessary.

When an order time of a part is optimized in such a way, production and delivery of the part by the part supplier 5 can be completed before exchange of the part, and thereby the user 4 can be provided with the part from the aircraft maker 3 according to an exchange time of the part. As a result, a down time of the aircraft 2 can be shortened to only a period required for exchanging the part, which can make a maintenance schedule of the aircraft 2 efficient and improve the operation rate of the aircraft 2.

Moreover, since the aircraft maker 3 can procure necessary parts at necessary timing, holding stock of parts by the aircraft maker 3 can also be made unnecessary.

### Other Implementations

While certain implementations have been described, these implementations have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, although the above-mentioned implementation shows an example of a case where the operation information acquiring part 1A, the exchange time specifying part 1B, the order time determining part 1C and the exchange time storage part 1D of the operation supporting system 1 are formed using the computer 6 placed on the aircraft maker 3 side, a part or all of the operation information acquiring part 1A, the exchange time specifying part 1B, the order time determining part 1C and the exchange time storage part 1D may be formed using a computer, such as the control system 7, mounted on the aircraft 2. In this case, exchange times of parts or order times of parts can be wirelessly transmitted from the aircraft 2 to the aircraft maker 3 side. When the aircraft 2 is a manned aircraft, a pilot can also understand exchange times of parts or order times of parts, and make use of them for planning a flight schedule and a maintenance plan of the aircraft 2.

Moreover, exchange times of parts or order times of parts may be notified to the user 4 in addition to the aircraft maker 3 or instead of the aircraft maker 3. In that case, the user 4 becomes possible to control the exchange times and order times of the parts included in the aircraft 2 by itself.

What is claimed is:

1. An operation supporting system of an aircraft comprising:
circuitry configured to:
automatically acquire, from an aircraft, identification data and flight time of the aircraft;
automatically specify exchange time of at least one part of the aircraft, based on the flight time of the aircraft; and
automatically determine order time of the at least one part, based on the exchange time of the at least one part.

2. The operation supporting system according to claim 1,
wherein the at least one part of the aircraft includes a part related to the engine of the aircraft, and
the circuitry is configured to:
automatically acquire, from the aircraft, driving time of the engine, and
automatically specify exchange time of the part related to the engine, based on the driving time of the engine.

3. The operation supporting system according to claim 2, further comprising:
storage storing first exchange time of a first part to be exchanged and second exchange time of a second part to be exchanged, the at least one part of the aircraft including the first and second parts, the second part consisting of the part related to the engine, the first exchange time of the first part being related to accumulated flight time of the aircraft after the first part has been exchanged to a new first part, the second exchange time of the second part being related to accumulated engine driving time of the engine after the second part has been exchanged to a new second part,
wherein the circuitry is configured to refer to the storage, and thereby specify the first exchange time of the first part based on the flight time of the aircraft and specify the second exchange time of the second part based on the driving time of the engine.

4. The operation supporting system according to claim 1,
wherein the circuitry is configured to predict forward flight time of the aircraft by liner approximation or curve approximation of change of past flight time of the aircraft and specify the exchange time of the at least one part based on the predicted forward flight time.

5. The operation supporting system according to claim 1,
wherein the circuitry is configured to determine, as the order time of the at least one part, time retroactive by lead time from the exchange time of the at least one part, the lead time being a period required from an order of the at least one part to a delivery of the at least one part.

6. The operation supporting system according to claim 1,
wherein the at least one part include parts of which fatigue lives have been defined, the parts including at least one of a blade of a rotorcraft, a transmission of a rotorcraft, a drive shaft of a rotorcraft, a propeller of a fixed wing aircraft and a part related to an engine of a fixed wing aircraft.

7. The operation supporting system according to claim 1,
wherein the circuitry is disposed on a ground, and
the circuitry is configured to acquire the identification data and the flight time of the aircraft by transmitting a first signal toward the aircraft wirelessly through a first radio placed on the ground and receiving a second signal through the first radio, the first signal requesting a transmission of the identification data and the flight time of the aircraft, the second signal being transmitted from a second radio mounted on the aircraft, the second signal being transmitted as a reply to the first signal.

8. The operation supporting system according to claim 7, further comprising:
another circuitry disposed in the aircraft,
wherein the another circuitry is configured to transmit the identification data and the flight time of the aircraft as second signal through the second radio when the another circuitry has received the first signal through the second radio.

9. A method of supporting operation of the aircraft comprising:
automatically determining the order time of the at least one part of the aircraft using the operation supporting system according to claim 1.

10. A method of supporting operation of an aircraft comprising:
acquiring, from an aircraft, identification data and flight time of the aircraft automatically by a computer;
specifying exchange time of at least one part of the aircraft, based on the flight time of the aircraft automatically by the computer; and
determining order time of the at least one part, based on the exchange time of the at least one part automatically by the computer.

11. A recording medium with a program of supporting operation of an aircraft recorded, the program making a computer execute to:
automatically acquire, from an aircraft, identification data and flight time of the aircraft;
automatically specify exchange time of at least one part of the aircraft, based on the flight time of the aircraft; and
automatically determine order time of the at least one part, based on the exchange time of the at least one part.

12. The method according to claim 10,
wherein the at least one part of the aircraft includes a part related to the engine of the aircraft, and
the method further includes:
acquiring, from the aircraft, driving time of the engine, automatically by the computer, and
specifying exchange time of the part related to the engine, based on the driving time of the engine, automatically by the computer.

13. The method according to claim 10, further comprising:
storing, in storage, first exchange time of a first part to be exchanged and second exchange time of a second part to be exchanged, the at least one part of the aircraft including the first and second parts, the second part consisting of the part related to the engine, the first exchange time of the first part being related to accumulated flight time of the aircraft after the first part has been exchanged to a new first part, the second exchange time of the second part being related to accumulated engine driving time of the engine after the second part has been exchanged to a new second part,
wherein the storage is referred to by the computer, and thereby the first exchange time of the first part is specified based on the flight time of the aircraft while the second exchange time of the second part is specified based on the driving time of the engine.

14. The method according to claim 10,
wherein forward flight time of the aircraft is predicted by liner approximation or curve approximation of change of past flight time of the aircraft, and the exchange time of the at least one part is specified based on the predicted forward flight time.

15. The method according to claim 10,
wherein time retroactive by lead time from the exchange time of the at least one part is determined as the order time of the at least one part, the lead time being a period required from an order of the at least one part to a delivery of the at least one part.

16. The method according to claim 10,
wherein the at least one part include parts of which fatigue lives have been defined, the parts including at least one of a blade of a rotorcraft, a transmission of a rotorcraft, a drive shaft of a rotorcraft, a propeller of a fixed wing aircraft and a part related to an engine of a fixed wing aircraft.

17. The method according to claim 10,
wherein the identification data and the flight time of the aircraft are acquired by transmitting a first signal toward the aircraft wirelessly through a first radio placed on a ground and receiving a second signal through the first radio, the first signal requesting a transmission of the identification data and the flight time of the aircraft, the second signal being transmitted from a second radio mounted on the aircraft, the second signal being transmitted as a reply to the first signal.

18. A method of supporting operation of the aircraft comprising:
automatically determining the order time of the at least one part of the aircraft using the operation supporting system according to claim 2.

19. A method of supporting operation of the aircraft comprising:
automatically determining the order time of the at least one part of the aircraft using the operation supporting system according to claim 3.

20. A method of supporting operation of the aircraft comprising:
automatically determining the order time of the at least one part of the aircraft using the operation supporting system according to claim 4.
